(19) United States
(12) Patent Application Publication
(10) Pub. No.: US 2015/0120723 A1
(43) Pub. Date: Apr. 30, 2015

(54) METHODS AND SYSTEMS FOR PROCESSING SPEECH QUERIES

(71) Applicant: Xerox Corporation, Norwalk, CT (US)

(72) Inventors: Om Deshmukh, Bangalore (IN); Anirban Mondal, Bangalore (IN); Koustuv Dasgupta, Bangalore (IN); Nischal M. Piratla, Fremont, CA (US)

(73) Assignee: XEROX CORPORATION, Norwalk, CT (US)

(21) Appl. No.: 14/061,780

(22) Filed: Oct. 24, 2013

(51) Int. Cl. G10L 15/08; G06F 17/30

(52) U.S. Cl. CPC G10L 15/08; G06F 17/30867
USPC 707/734

(57) ABSTRACT

The disclosed embodiments illustrate methods and systems for processing a speech query received from a user. The method comprises determining one or more interpretations of the speech query using an ASR technique that utilizes a database comprising one or more interpretations of each of one or more pre-stored speech queries and a profile of each of one or more crowdworkers. The one or more interpretations are received as one or more responses from the one or more crowdworkers, in response to each of the one or more pre-stored speech queries being offered as one or more crowdsourced tasks to the one or more crowdworkers. Further, one or more search results retrieved based on the one or more determined interpretations are ranked, based on a comparison of a profile of the user with the profile of each of the one or more crowdworkers associated with the one or more determined interpretations.

### TECHNICAL FIELD

The presently disclosed embodiments are related, in general, to crowdsourcing. More particularly, the presently disclosed embodiments are related to methods and systems for processing speech queries using crowdsourcing.

### BACKGROUND

With the development of automatic speech recognition (ASR) technology, several speech-based information retrieval (SBIR) systems have emerged. An SBIR system may use an ASR engine that utilizes a database comprising a repository of known words and speech patterns corresponding to the known words. In order to populate the repository, the ASR engine is trained on a sample set of speech patterns based on one or more speech-to-text conversion heuristics. Further, the repository may be updated as and when the ASR engine encounters speech patterns corresponding to new words. When a user queries the SBIR system by providing a suitable speech input, the SBIR system may interpret the speech input using the ASR engine. If the speech input is determined to be similar to a speech pattern of a known word in the repository, the ASR engine interprets the speech input as the known word. Otherwise, the ASR engine may interpret the speech input by employing the one or more speech-to-text conversion heuristics.

The SBIR system may retrieve one or more search results related to the speech input based on the interpretation of the speech input determined by the ASR engine. However, the speech input may be subject to variations due to varying user demographics. Further, the speech input may include one or more unrecognized words such as proper nouns, which may have several possible interpretations. The ASR engine may not be able to interpret such speech inputs properly, which may result in the retrieval of irrelevant search results by the SBIR system. Thus, there is a need for a solution that overcomes such limitations in the processing of speech queries.

### SUMMARY

According to embodiments illustrated herein, there is provided a method for processing a speech query received from a user. The method comprises determining, by one or more processors, one or more interpretations of the speech query using automatic speech recognition (ASR) technique, wherein the ASR technique utilizes a database comprising one or more interpretations associated with each of one or more pre-stored speech queries and a profile of each of one or more crowdworkers. The one or more interpretations associated with each of the one or more pre-stored speech queries are received as one or more responses from the one or more crowdworkers, in response to each of the one or more pre-stored speech queries being offered as one or more crowdsourced tasks to the one or more crowdworkers. Further, one or more search results retrieved based on the one or more determined interpretations are ranked by the one or more processors, wherein the ranking is based on a comparison of a profile of the user, with the profile of each of the one or more crowdworkers associated with the one or more determined interpretations.

According to embodiments illustrated herein, there is provided a system for processing a speech query received from a user. The system includes one or more processors that are operable to determine one or more interpretations of the speech query using automatic speech recognition (ASR) technique, wherein the ASR technique utilizes a database comprising one or more interpretations associated with each of one or more pre-stored speech queries and a profile of each of one or more crowdworkers. The one or more interpretations associated with each of the one or more pre-stored speech queries are received as one or more responses from the one or more crowdworkers in response to each of the one or more pre-stored speech queries being offered as one or more crowdsourced tasks to the one or more crowdworkers. Further, one or more search results retrieved based on the one or more determined interpretations are ranked, wherein the ranking is based on a comparison of a profile of the user with the profile of each of the one or more crowdworkers associated with the one or more determined interpretations.

According to embodiments illustrated herein, there is provided a computer program product for use with a computing device. The computer program product comprises a non-transitory computer readable medium, the non-transitory computer readable medium stores a computer program code for processing a speech query received from a user. The computer readable program code is executable by one or more processors in the computing device to determine one or more interpretations of the speech query using an automatic speech recognition (ASR) technique, wherein the ASR technique utilizes a database comprising one or more interpretations associated with each of one or more pre-stored speech queries and a profile of one or more crowdworkers. The one or more interpretations associated with each of the one or more pre-stored speech queries are received as one or more responses from the one or more crowdworkers, in response to each of the one or more pre-stored speech queries being offered as one or more crowdsourced tasks to the one or more crowdworkers. Further, one or more search results retrieved based on the one or more determined interpretations are ranked, wherein the ranking is based on a comparison of a profile of the user with the profile of each of the one or more crowdworkers associated with the one or more determined interpretations.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented;

FIG. 2 is a block diagram that illustrates a system for processing a speech query received from a user, in accordance with at least one embodiment;

FIGS. 3A and 3B together constitute a flowchart that illustrates a method for processing a speech query received from a user, in accordance with at least one embodiment; and

FIG. 4 is a flowchart that illustrates a method for validating a response received from a crowdworker, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “task” refers to a piece of work, an activity, an action, a job, an instruction, or an assignment to be performed. Tasks may necessitate the involvement of one or more workers. Examples of tasks include, but are not limited to, digitizing a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk and Crowd Flower.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk or Crowd Flower.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be interchangeably used.

A “performance score” refers to a score indicative of a performance of a crowdworker on a set of tasks. In an embodiment, performance score of a crowdworker may be determined as a ratio of the number of valid responses provided by the crowdworker for one or more tasks to the total number of responses provided by the crowdworker for the one or more tasks.

“Profile of a person” refers to demographic details of the person, including, but not limited to, gender, age group, ethnicity, nationality, and mother tongue.

A “speech query” refers to a search query provided by a user as a speech input. The speech input may include one or more search terms associated with the search query. For example, “Where is Alabama?” is a search query that is spoken into the system for searching purposes.

“Automatic Speech Recognition (ASR)” is a technique of interpreting a speech input received from a user by converting the received speech input into a textual equivalent using one or more speech-to-text conversion heuristics and/or one or more speech processing techniques such as, but not limited to, Hidden Markov Model (HMM), Dynamic Time Warping (DWT)-based speech recognition, and neural networks. In an embodiment, an ASR engine utilizes a repository of known words and speech patterns corresponding to the known words. Initially, the ASR engine may be trained to recognize speech inputs using a sample set of speech patterns based the one or more speech-to-text conversion heuristics. Further, the repository may be updated as and when the ASR engine encounters speech patterns corresponding to new words. In an embodiment, the ASR engine may determine the interpretation of the speech input based on a comparison of the speech input with the speech patterns corresponding to the known words stored in the repository. If the ASR engine determines that the speech input is similar to a speech pattern of a known word in the repository, the ASR engine may interpret the speech input as the known word. Otherwise, the ASR engine may interpret the speech input by employing the one or more speech-to-text heuristics.

A “speech-based information retrieval (SBIR) system” is an information retrieval system that retrieves one or more search results related to a speech query provided by a user based on an interpretation of the speech query determined using an ASR engine. Examples of SBIR systems include, but are not limited to, Google® Voice Search, Bing® Voice Search, and Dragon® Search.

A “response” refers a reply received from a crowdworker for a crowdsourced task, which is offered to the crowdworker. The reply may include a result for the crowdsourced task, which is obtained when the crowdsourced task is performed by the crowdworker. The response may include at least one of one or more speech input or one or more textual inputs.

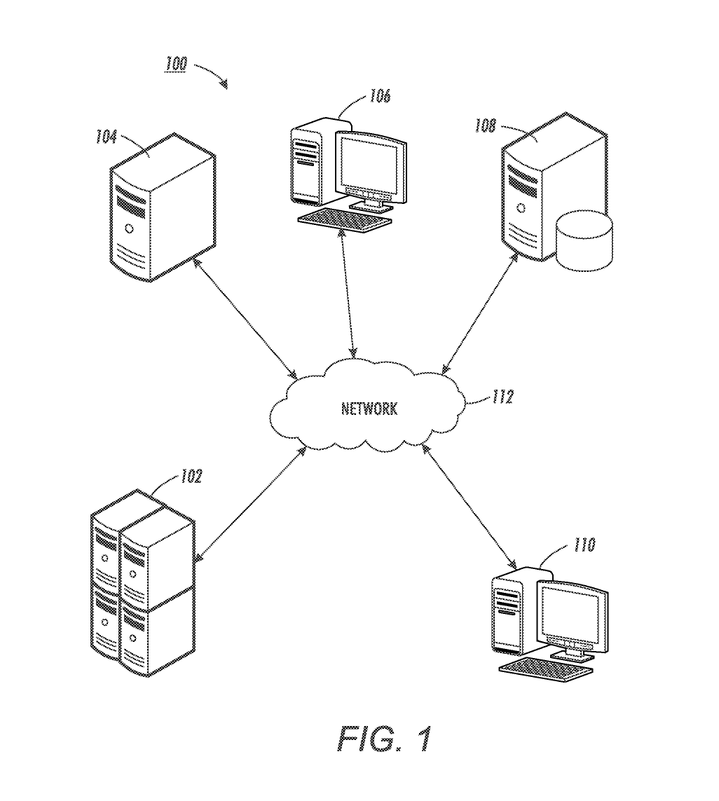

FIG. 1 is a block diagram of a system environment 100, in which various embodiments can be implemented. The system environment 100 includes a crowdsourcing platform server 102, an application server 104, a user-computing device 106, a database server 108, a crowdworker-computing device 110, and a network 112.

The crowdsourcing platform server 102 is operable to host one or more crowdsourcing platforms. One or more crowdworkers are registered with the one or more crowdsourcing platforms. Further, the crowdsourcing platform offers one or more tasks to the one or more crowdworkers. In an embodiment, the crowdsourcing platform presents a user interface to the one or more crowdworkers through a web-based interface or a client application. The one or more crowdworkers may access the one or more tasks through the web-based interface or the client application. Further, the one or more crowdworkers may submit a response to the crowdsourcing platform through the user interface.

In an embodiment, the crowdsourcing platform server 102 may be realized through an application server such as, but not limited to, a Java application server, a .NET framework, and a Base4 application server.

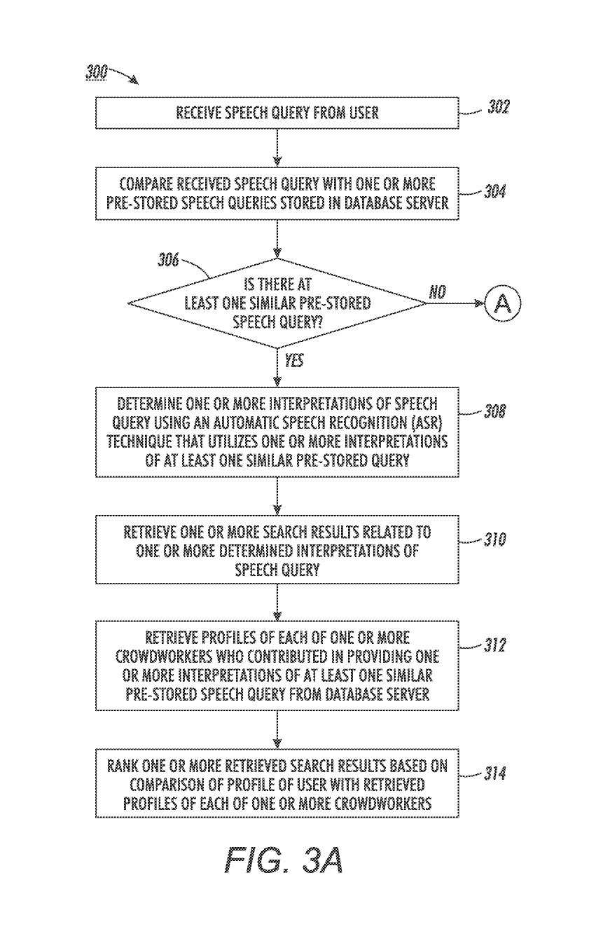

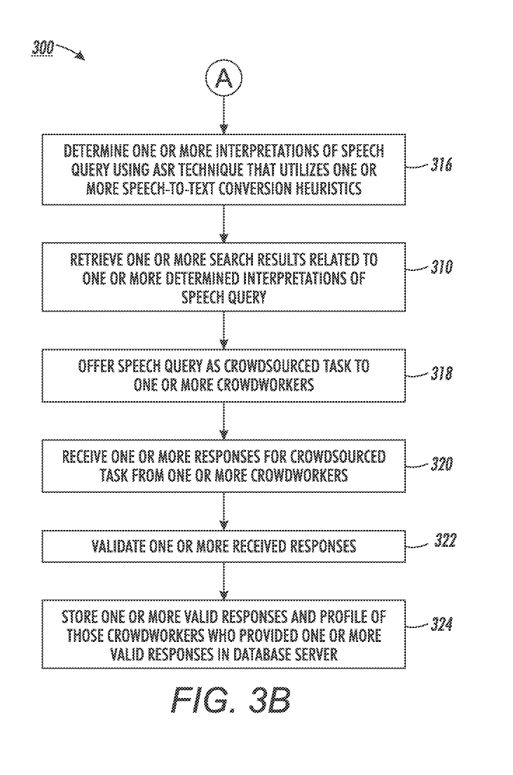

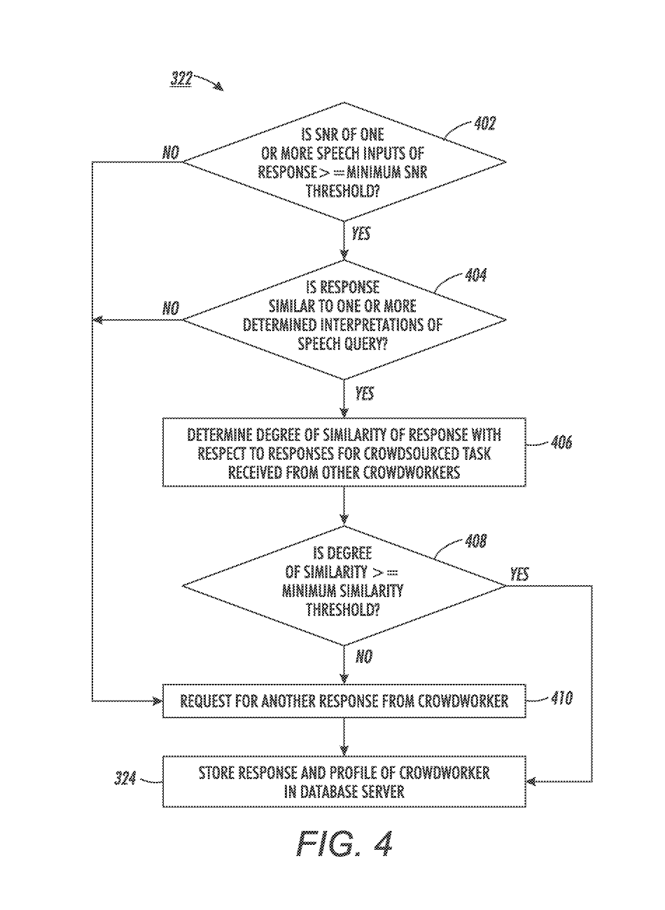

In an embodiment, the application server 104 is operable to receive a speech query from the user-computing device 106. The application server 104 includes an ASR engine that compares the received speech query with one or more pre-stored speech queries stored by the database server 108. If the speech query is determined to be similar to at least one of the one or more pre-stored speech queries, the application server 104 determines one or more interpretations of the speech query using the ASR engine. However, if the speech query is determined to be different from each of the one or more pre-stored speech queries, the application server 104 uploads the speech query as a crowdsourced task to the crowdsourcing platform. The processing of the speech query is further explained with respect to FIGS. 3A and 3B. In an embodiment, the application server 104 receives one or more responses for the crowdsourced task from the one or more crowdworkers through the crowdsourcing platform. Further, the application server 104 validates the one or more received responses. The validation of the one or more responses is further explained with respect to FIG. 4. The application server 104 stores valid responses from the one or more received responses and profiles of crowdworkers who provided these valid responses on the database server 108.

Some examples of the application server 104 may include, but are not limited to, a Java application server, a .NET framework, and a Base4 application server.

A person with ordinary skill in the art would understand that the scope of the disclosure is not limited to illustrating the application server 104 as a separate entity. In an embodiment, the functionality of the application server 104 may be implementable on/integrated with the crowdsourcing platform server 102.

The user-computing device 106 is a computing device used by a user to send the speech query to the application server 104. In an embodiment, the user-computing device 106 includes a speech input device such as a microphone to receive one or more speech inputs associated with the speech query from the user. Examples of the user-computing device 106 include, but are not limited to, a personal computer, a laptop, a personal digital assistant (PDA), a mobile device, a tablet, or any other computing device.

The database server 108 stores the one or more pre-stored speech queries, one or more interpretations associated with each of the one or more pre-stored speech queries, a profile of each of the one or more crowdworkers and a profile of the user of the user-computing device 106. In an embodiment, the database server 108 may receive a query from the crowdsourcing platform server 102 and/or the application server 104 to extract at least one of the one or more pre-stored speech queries, the one or more interpretations associated with each of the one or more pre-stored speech queries, the profiles of the one or more crowdworkers, or the profile of the user from the database server 108. In an embodiment, the database server 108 may also store indexed searchable data such as, but not limited to images, text files, audio, video, or multimedia content. In an embodiment, the application server 104 may query the database server 108 to retrieve one or more search results related to the speech query from the indexed searchable data stored on the database server 108.

The database server 108 may be realized through various technologies such as, but not limited to, Microsoft® SQL server, Oracle, and My SQL. In an embodiment, the crowdsourcing platform server 102 and/or the application server 104 may connect to the database server 108 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 108 as a separate entity. In an embodiment, the functionalities of the database server 108 can be integrated into the crowdsourcing platform server 102 and/or the application server 104.

The crowdworker-computing device 110 is a computing device used by a crowdworker. The crowdworker-computing device 110 is operable to present the user interface (received from the crowdsourcing platform) to the crowdworker. The crowdworker receives the one or more crowdsourced tasks from the crowdsourcing platform through the user interface. Thereafter, the crowdworker submits the responses for the crowdsourced tasks through the user interface to the crowdsourcing platform. In an embodiment, the crowdworker-computing device 110 includes a speech input device, such as a microphone, to receive one or more speech inputs from the crowdworker. Further, the crowdworker-computing device 110 includes a text input device such as, but not limited to, a touch screen, a keypad, a keyboard, or any other user input device, to receive one or more textual inputs from the crowdworker. Examples of the crowdworker-computing device 110 include, but are not limited to, a personal computer, a laptop, a personal digital assistant (PDA), a mobile device, a tablet, or any other computing device.

The network 112 corresponds to a medium through which content and messages flow between various devices of the system environment 100 (e.g., the crowdsourcing platform server 102, the application server 104, the user-computing device 106, the database server 108, and the crowdworker-computing device 110). Examples of the network 112 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

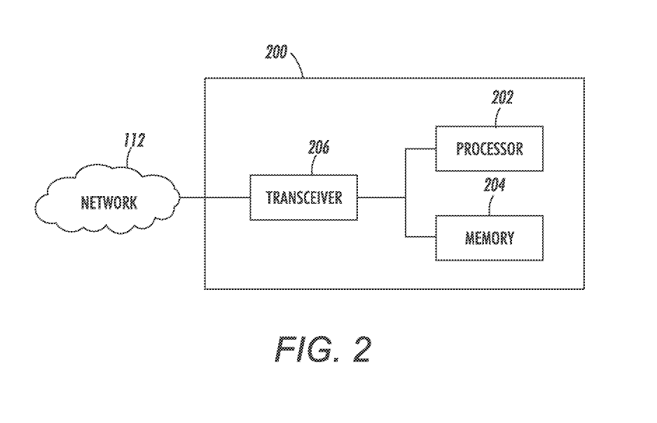

FIG. 2 is a block diagram that illustrates a system 200 for processing the speech query received from the user, in accordance with at least one embodiment. In an embodiment, the system 200 may correspond to the crowdsourcing platform server 102 or the application server 104. For the purpose of ongoing description, the system 200 is considered as the application server 104. However, the scope of the disclosure should not be limited to the system 200 as the application server 104. The system 200 can also be realized as the crowdsourcing platform server 102.

The system 200 includes a processor 202, a memory 204, and a transceiver 206. The processor 202 is coupled to the memory 204 and the transceiver 206. The transceiver 206 is connected to the network 112.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the user-computing device 106, the database server 108, and the crowdworker-computing device 110) over the network 112. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

The operation of the system 200 for processing of the speech query has been described in conjunction with FIGS. 3A and 3B.

FIGS. 3A and 3B together constitute a flowchart 300 illustrating a method for processing the speech query received from the user, in accordance with at least one embodiment. The flowchart 300 is described in conjunction with FIGS. 1 and 2.

At step 302, the speech query is received from the user. In an embodiment, the processor 202 receives the speech query from the user-computing device 106 of the user through the transceiver 206. In an embodiment, the received speech query includes one or more search terms for information retrieval.

At step 304, the received speech query is compared with each of the one or more pre-stored speech queries stored in the database server 108. In an embodiment, the processor 202 retrieves the one or more pre-stored speech queries from the database server 108 and compares each of the one or more pre-stored speech queries with the received speech query. In an embodiment, the processor 202 compares the speech query with the one or more pre-stored speech queries using a speech-level comparison technique such as, but not limited to, a syllable-level comparison, a frame-level Dynamic Time Warping (DTW) comparison, or any other speech comparison technique.

In an embodiment, the one or more pre-stored speech queries correspond to speech queries that were received prior to the currently received speech query (i.e., the speech query received at step 302). In an embodiment, prior to receiving the current speech query, each of the one or more pre-stored speech queries was offered as a crowdsourced task to the one or more crowdworkers. Further, the one or more interpretations associated with each of the one or more pre-stored speech queries were determined based on one or more responses received from the one or more crowdworkers for the crowdsourced task. The process of offering a speech query as a crowdsourced task to one or more crowdworkers has been explained with reference to FIG. 3B. Further, the process of validation of the one or more responses received from the one or more crowdworkers has been explained with reference to FIG. 4. Valid responses from the one or more received responses and profiles of crowdworkers who provided these valid responses are stored on the database server 108.

At step 306, a check is performed to determine whether there is at least one similar pre-stored speech query in the one or more pre-stored speech queries. In an embodiment, the processor 202 is operable to perform the check. If the processor 202 determines that there is at least one similar pre-stored speech query in the database server 108, step 308 (refer to FIG. 3A) is performed, and otherwise, step 318 (refer to FIG. 3B) is performed.

At step 308, the one or more interpretations of the speech query are determined using an ASR technique that utilizes one or more interpretations of the at least one similar pre-stored speech query. In an embodiment, the processor 202 uses the ASR engine to determine the one or more interpretations of the speech query. To that end, the ASR engine extracts the one or more interpretations of the at least one similar pre-stored speech query from the database server 108. The ASR engine considers the one or more interpretations of the at least one similar pre-stored speech query as the one or more interpretations of the speech query. For example, the user may send the speech query such as “What is football?”. The ASR engine determines that there exists one pre-stored speech query in the database server 108 (such as “Types of football”), which is similar to this speech query (“What is football?”). Thereafter, the ASR engine extracts one or more interpretations associated with this similar pre-stored speech query from the database server 108. The following table illustrates the one or more interpretations of the pre-stored speech query.

TABLE 1
An example of interpretations of a pre-stored speech query

| | | Crowdworkers |
|---|---|---|
| Pre-stored | | who provided |
| speech query | Interpretations | interpretations |
| “Types of football” | Soccer | Crowdworker C1 |
| | (or association football) | |
| | Rugby | Crowdworker C2 |
| | Australian football | Crowdworker C3 |
| | American football | Crowdworker C4 |
| | Gaelic football | Crowdworker C5 |

The ASR engine determines the one or more interpretations of the speech query (“What is football?”) as soccer, rugby, Australian football, American football, and Gaelic football. Further, the profiles of crowdworkers (such as C1, C2, C3, C4, and C5) who provided these interpretations of the similar pre-stored speech query are present in the database server 108.

At step 310, the one or more search results related to the one or more interpretations of the speech query are retrieved. In an embodiment, the processor 202 is operable to retrieve the one or more search results related to the one or more interpretations of the speech query. In an embodiment, the processor 202 may retrieve the one or more search results from a search engine such as, but not limited to, Google®, Bing®, Yahoo!®, or any other search engine. In another embodiment, the processor 202 may retrieve the one or more search results from the indexed searchable data stored on the database server 108.

At step 312, a profile of each crowdworker in a first set of crowdworkers is retrieved from the database server 108. In an embodiment, the processor 202 retrieves the profile of each crowdworker in the first set of crowdworkers from the database server 108. In an embodiment, the first set of crowdworkers corresponds to crowdworkers who contributed in providing the one or more interpretations of the at least one similar pre-stored speech query.

In addition, the processor 202 may also retrieve the profile of the user from the database server 108. However, if the profile of the user is not present in the database server 108, the processor 202 may prompt the user to input details associated with the profile through the user-computing device 106. Further, the processor 202 may generate the profile of the user based on the inputted details and store the generated profile in the database server 108.

In an embodiment, the profile of the crowdworker or the user may include demographic details including, but not limited to, gender, age group, ethnicity, nationality, mother tongue, etc.

At step 314, the one or more retrieved search results are ranked. In an embodiment, the processor 202 ranks the one or more retrieved search results based on a comparison of the profile of the user with the profile of each crowdworker in the first set of crowdworkers. In an embodiment, the comparison of profiles may be performed using one or more pattern matching techniques such as, but not limited to, fuzzy logic, neural networks, k-means clustering, k-nearest neighbor classification, regression based clustering, or any other technique known in the art. Post the comparison, the processor 202 ranks the one or more search results based on the comparison. In an embodiment, higher the similarity between the profile of the set of crowdworkers and the profile of the user, higher is the rank assigned to search results associated with interpretations provided by the set of crowdworkers. Such a ranking would ensure a higher rank for search results that are demographically more relevant. In the above example (refer to Table 1), the crowdworkers C4 and C2 (who contributed in providing the interpretations “American football” and “Rugby”, respectively) may belong to the United States. Further, if the user were a native of the United States, the profile of the user may be very similar to the profiles of crowdworkers C4 and C2. As the ranking of the search results is based on the similarity of the profile of the user with the profiles of the crowdworkers, results related to “American football” and “Rugby” would be ranked higher than results obtained based on the other interpretations of the speech query. Thus, the search results associated with the interpretations provided by crowdworkers with profiles similar to the profile of the user are ranked higher thereby ensuring a higher ranking to contextually relevant results.

In an embodiment, the ranking of the one or more search results may also be based on a performance score associated with each of the one or more crowdworkers. For example, if crowdworkers A, B, and C, with performance scores of 0.8, 0.3, and 0.6, respectively, had provided the one or more interpretations, the search results retrieved based on interpretations provided by A are ranked higher than those of C, followed by B. In an embodiment, the performance score of a crowdworker is calculated as a ratio of the number of valid responses provided by the crowdworker to the total number of responses provided by the crowdworker. The validation of responses is explained with reference to FIG. 4.

Further, in an embodiment, the ranking may be based on a weighted sum of a degree of similarity between the profiles of the crowdworkers and the profile of the user and the performance scores of the crowdworkers. In the above example, if the degrees of similarity of the profiles of the crowdworkers (A, B, and C) with respect to the profile of the user are 0.6, 0.4, and 0.9, respectively (that is the profiles are 70%, 50%, and 90% similar, respectively), the weighted sum may be determined as {0.8*x+0.6*y)}, {0.3*x+0.4*y)}, and {0.6*x+0.9*y)}, respectively. Here, ‘x’ and ‘y’ correspond to weights lying between 0 and 1. For example, if x and y are 0.6 and 0.8, respectively, the weighted sums of the degrees of similarity and the performance scores of the crowdworkers (A, B, and C) evaluate to 0.96, 0.5, and 1.08, respectively. Thus, in this example, the search results retrieved based on interpretations provided by C are ranked higher than those of A, followed by B.

Post the ranking of the search results, the processor 202 sends the one or more ranked search results to the user-computing device 106 through the transceiver 206. The one or more ranked search results are presented to the user on the user-computing device 106.

A person skilled in the art would appreciate that the scope of the disclosure with respect to the ranking of the one or more retrieved search results should not be limited to that mentioned in the disclosure. The ranking of the one or more retrieved search results may be implemented with one or more variations without departing from the spirit of the disclosure.

When the processor 202 determines at step 306 that the speech query is different from each of the one or more pre-stored speech queries stored in the database server 108 (i.e., none of the pre-stored speech queries is determined to be similar to the speech query), step 316 is performed.

At step 316, one or more interpretations of the speech query are determined using an ASR technique that utilizes the one or more speech-to-text conversion heuristics. In an embodiment, the processor 202 may use the ASR engine, which may in turn utilize the one or more speech-to-text conversion heuristics to determine the one or more interpretations the speech query. In an embodiment, the one or more speech-to-text conversion heuristics may include one or more speech recognition techniques such as, but not limited to, Hidden Markov Model (HMM), Dynamic Time Warping (DTW)-based speech recognition, and neural networks.

For example, if the speech query contains a proper noun such as a name of a person, which is not present in the database server 108, the speech query would be interpreted by converting the speech query into one or more textual equivalents based on the one or more speech-to-text conversion heuristics. Further, in such a scenario, the retrieval of the one or more search results associated with the speech query (as explained in step 310) would be based on the one or more textual equivalents of the speech query (as determined in step 316).

Concurrently, at step 318, the speech query is offered as the crowdsourced task to the one or more crowdworkers. In an embodiment, the processor 202 offers the speech query as the crowdsourced task to the one or more crowdworkers through the crowdsourcing platform. In an embodiment, the processor 202 sends the speech query to the crowdsourcing platform through the transceiver 206. Thereafter, the crowdsourcing platform offers the speech query as the crowdsourced task to the one or more crowdworkers on the crowdworker-computing device 110 of each of the one or more crowdworkers.

At step 320, the one or more responses for the crowdsourced task are received from the one or more crowdworkers. In an embodiment, the processor 202 receives the one or more responses for the crowdsourced task from the one or more crowdworkers through the crowdsourcing platform via the transceiver 206.

In an embodiment, each of the one or more responses comprises at least one of one or more speech inputs or one or more textual inputs. In an embodiment, the one or more speech inputs comprise at least one of one or more spoken interpretations of the speech query or one or more spoken variations of the speech query. In an embodiment, the one or more textual inputs comprise at least one of one of one or more phonetic transcriptions of the speech query or one or more textual interpretations of the speech query. For example, for a speech query such as “Who is Fred?”, one or more interpretations (spoken or textual) may include “Identify the person named Fred”, “Give details about Fred”, etc. Further, one or more phonetic transcriptions of this speech query (“Who is Fred?”) may include |hu: z fred|, etc.

At step 322, the one or more received responses are validated. In an embodiment, the processor 202 validates the one or more received responses. Step 322 has been further explained through a flowchart 322 of FIG. 4.

At step 324, one or more valid responses and profiles of a second set of crowdworkers from the one or more crowdworkers are stored in the database server 108. In an embodiment, the second set of crowdworkers corresponds to the crowdworkers who provided the one or more valid responses. In an embodiment, the processor 202 stores the speech query, the one or more valid responses, and the profiles of the second set of crowdworkers in the database server 108. In an embodiment, the one or more valid responses and the speech query (stored in step 324) are used by the ASR engine as the pre-stored speech query when the ASR engine encounters similar speech query in the future.

Thereafter, in an embodiment, when a new speech query is received and is determined to be similar to the speech query (stored in step 324), one or more interpretations of the new speech query may be determined based on the one or more valid responses (received from the crowdworkers as described in steps 320 and 322). Further, ranking of one or more search results retrieved based on the determined one or more interpretations of the new speech query may be based on a comparison of the profile of the user with the profile of each crowdworker in the second set of crowdworkers who provided the one or more valid responses, as is explained in step 314.

For example, speech queries about current affairs may be received from users on a frequent basis. Such speech queries may contain only proper nouns or may be such that proper nouns form the most informative part of the speech query. For example, after a social event such as launch of Apple® iPhone 5C, the speech query would be “iPhone 5C” rather than “launch of cheapest iPhone by Apple”. If interpretations of such speech query are not already present in the database server 108, the speech query may be offered as a crowdsourced task to the one or more crowdworkers. Crowdworkers having varied demographics and having awareness about such events may provide relevant interpretations for the speech query. As the database server 108 would be up-to-date with interpretations of such speech queries as per the responses provided by the one or more crowdworkers, speech based information retrieval would be relevant to the current context of such speech queries.

FIG. 4 is a flowchart 322 that illustrates a method for validating a response received from a crowdworker, in accordance with at least one embodiment. The flowchart 322 is described in conjunction with FIGS. 1 and 2.

Although the disclosure explains the validation of a response received from one of the crowdworkers, a person skilled in the art would understand that each of the one or more responses received from the one or more crowdworkers may be validated in a similar manner.

At step 402, a check is performed to determine whether a signal-to-noise ratio (SNR) of the one or more speech inputs of the response is greater than or equal to a minimum SNR threshold. In an embodiment, the processor 202 is operable to perform this check. If the processor 202 determines that the SNR of the one or more speech inputs is greater than or equal to the minimum SNR threshold, step 316 is performed, and otherwise, step 410 is performed.

The comparison of the SNR of the one or more speech inputs with the minimum SNR threshold reveals whether the one or more speech inputs are noisy. If the SNR of the one or more speech inputs is less than the minimum SNR threshold, the one or more speech inputs may have significant noise and may be difficult to interpret.

Further, a person skilled in the art would understand that step 402 might be performed only when the response includes at least one speech input. In a scenario where the response does not include a speech input, step 402 can be skipped.

At step 404, a check is performed to determine whether the response is similar to the one or more interpretations of the speech query determined by the ASR engine (as described in step 316 using the one or more speech-to-text heuristics). In an embodiment, the processor 202 is operable to perform this check. To that end, in an embodiment, the processor 202 compares the one or more textual inputs of the response with the one or more determined interpretations of the speech query. If the processor 202 determines that the response is similar to the one or more determined interpretations of the speech query, step 406 is performed, and otherwise, step 410 is performed.

A person skilled in the art would appreciate that the determination of a high level of similarity of the response with the one or more interpretations of the speech query determined using the one or more speech-to-text heuristics might be a prima facie indicator of the validity of the response.

In an embodiment, step 404 may be performed when the count of the one or more received responses is less than a minimum response count threshold. Further, in such a scenario, steps 406 and 408 may be skipped. This would ensure that an initial set of responses are not rejected if found to be different from one another. Their difference might be due to varying demographics of the crowdworkers who provided these responses. Hence, these responses may be validated based on their similarity with respect to the one or more interpretations of the speech query, as described in step 404.

Further, in a scenario where the count of the one or more received responses is greater than or equal to the minimum response count threshold, step 404 may be skipped, while steps 406 and 408 may be performed.

At step 406, a degree of similarity of the response with respect to the responses for the crowdsourced task received from the other crowdworkers is determined. In an embodiment, the processor 202 determines the degree of similarity of the response with respect to the responses for the crowdsourced task received from the other crowdworkers.

In a scenario where the response includes one or more textual inputs, the processor 202 may determine the degree of similarity by performing a text-based comparison. In an embodiment, the text-based comparison may be performed by determining an average minimum edit distance of the one or more textual inputs included in the response with respect to the one or more textual inputs included in the other responses. In an embodiment, a Hamming distance may be used as the average minimum edit distance between two textual inputs being compared, which are of the same length as regards to their phonetic composition or other metric. The Hamming distance may be determined as the number of differing symbols in the two textual inputs. For example, if the two textual inputs are “roses” and “hoses”, the Hamming distance (and, hence, the average minimum distance) is one, as one character is different in the two textual inputs. In another embodiment, a Levenshtein distance may be used as the average minimum edit distance between two textual inputs being compared, which may or may not be of the same length. The Levenshtein distance may be determined as the minimum number of edits (i.e., a combination of deletions, insertions, and substitutions), which are needed to make the two textual inputs the same. For example, if the two textual inputs are “roses” and “phases” the Levenshtein distance (and hence the average minimum distance) is three, as two substitutions (i.e., ‘p’ instead of ‘r’ and ‘h’ instead of ‘o’) and one insertion (i.e., character ‘a’ inserted at the third location) are required to edit the word “roses” to the word “phases”.

A person with ordinary skill in the art would understand that the average minimum distance may be determined using any other string matching technique known in the art, without departing from the spirit of the disclosure. The scope of the disclosure with respect to the determination of the average minimum distance should not be limited to that mentioned in the disclosure.

In an alternate scenario where the response includes one or more speech inputs, the processor 202 may determine the degree of similarity by performing a speech-level comparison of the one or more speech inputs included in the response with respect to the one or more speech inputs included in the other responses. In an embodiment, the speech-level comparison may be performed using speech comparison techniques such as, but not limited to, a syllable-level comparison, a frame-level Dynamic Time Warping (DTW) comparison, or any other speech comparison technique.

A person with ordinary skill in the art would understand that the degree of similarity may be determined using any other technique, without departing from the spirit of the disclosure. The scope of the disclosure with respect to the determination of the degree of similarity should not be limited to that mentioned in the disclosure.

At step 408, a check is performed to determine whether the degree of similarity is greater than or equal to a minimum similarity threshold. In an embodiment, the processor 202 is operable to perform the check. If the processor 202 determines that the degree of similarity is greater than or equal to the minimum similarity threshold, step 324 is performed. At step 324, the response and the profile of the crowdworker are stored in the database server 108. In an embodiment, the processor 202 stores the response provided by the crowdworker and the profile of the crowdworker in the database server 108. Step 324 has already been described with respect to FIG. 3B with reference to the one or more validated responses and the second set of crowdworkers who provided the one or more validated responses.

If at step 408, the processor 202 determines that the degree of similarity is less than the minimum similarity threshold, step 410 is performed. At step 410, the crowdworker is requested for another response. In an embodiment, the processor 202 requests the crowdworker for another response through the crowdsourcing platform via the transceiver 206.

A person skilled in the art would appreciate that the scope of the disclosure should not be limited with respect to the validation of the one or more responses received from the one or more crowdworkers, as explained above. The validation of the one or more responses may be implemented with one or more variations, without departing from the spirit of the disclosure.

The disclosed embodiments encompass numerous advantages. Various embodiments of the disclosure lead to improved interpretation of speech queries The offering of a speech query as a crowdsourced task to a diverse group of crowdworkers ensures demographic diversity in one or more responses received from the group of crowdworkers. When a similar speech query is received in future, one or more interpretations of the similar speech query may be determined based on the responses previously received from the crowdworkers. As the responses have been provided by demographically diverse crowdworkers, therefore, demographic diversity of the one or more interpretations of the similar speech query would also be ensured. Further, demographic diversity of one or more search results retrieved based on these one or more interpretations would also be ensured.

As already discussed, one or more search results related to the speech query are retrieved based on the one or more determined interpretations of the speech query. The one or more retrieved search results are ranked based on a comparison of a profile of the user with a profile of each of the one or more crowdworkers. Such a ranking would ensure a higher rank for search results that are demographically more relevant. For example, if a user belongs to the Indian state of Karnataka and speaks Kannada and English, a set of search results retrieved based on interpretations provided by crowdworkers from Karnataka who speak Kannada and English would be ranked higher than the rest of the one or more retrieved search results. Thus, the search results that are more contextually relevant to the specific user would be ranked higher.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for processing a speech query received from a user have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for processing a speech query received from a user, the method comprising:
determining, by one or more processors, one or more interpretations of the speech query using an automatic speech recognition (ASR) technique, wherein the ASR technique utilizes a database comprising one or more interpretations associated with each of one or more pre-stored speech queries and a profile of each of one or more crowdworkers, wherein the one or more interpretations associated with each of the one or more pre-stored speech queries are received as one or more responses from the one or more crowdworkers, in response to each of the one or more pre-stored speech queries being offered as one or more crowdsourced tasks to the one or more crowdworkers; and
ranking, by the one or more processors, one or more search results retrieved based on the one or more determined interpretations, wherein the ranking is based on a comparison of a profile of the user with the profile of each of the one or more crowdworkers associated with the one or more determined interpretations.

2. The method of claim 1 further comprising comparing, by the one or more processors, the speech query with the one or more pre-stored speech queries.

3. The method of claim 2, wherein the one or more interpretations of the speech query are determined using the ASR technique, when the speech query is determined to be similar to at least one of the one or more pre-stored speech queries based on the comparison.

4. The method of claim 2 further comprising offering, by the one or more processors, the speech query as a crowdsourced task to the one or more crowdworkers, when the speech query is determined to be different from each of the one or more pre-stored speech queries based on the comparison.

5. The method of claim 1, wherein each of the one or more responses comprises at least one of one or more speech inputs or one or more textual inputs, wherein the one or more speech inputs comprise at least one of one or more spoken interpretations of the pre-stored speech query or one or more spoken variations of the pre-stored speech query, wherein the one or more textual inputs comprise at least one of one or more phonetic transcriptions of the pre-stored speech query or one or more textual interpretations of the pre-stored speech query.

6. The method of claim 5 further comprising validating, by the one or more processors, a response received from a crowdworker of the one or more crowdworkers based on at least one of the ASR technique, a comparison of signal-to-noise ratio (SNR) of the one or more speech inputs of the response with a minimum SNR threshold, or a degree of similarity of the response with remaining of the one or more responses.

7. The method of claim 6 further comprising storing, by the one or more processors, the response as the one or more interpretations associated with the pre-stored speech query and a profile of the crowdworker in the database, when the response is determined to be valid based on the validation.

8. A system for processing a speech query received from a user, the system comprising:
one or more processors operable to:
determine one or more interpretations of the speech query using an automatic speech recognition (ASR) technique, wherein the ASR technique utilizes a database comprising one or more interpretations associated with each of one or more pre-stored speech queries and a profile of each of one or more crowdworkers, wherein the one or more interpretations associated with each of the one or more pre-stored speech queries are received as one or more responses from the one or more crowdworkers, in response to each of the one or more pre-stored speech queries being offered as one or more crowdsourced tasks to the one or more crowdworkers, and
rank one or more search results retrieved based on the one or more determined interpretations, wherein the ranking is based on a comparison of a profile of the user with the profile of each of the one or more crowdworkers associated with the one or more determined interpretations.

9. The system of claim 8, wherein the one or more processors are further operable to compare the speech query with the one or more pre-stored speech queries.

10. The system of claim 9, wherein the one or more interpretations of the speech query are determined using the ASR technique, when the speech query is determined to be similar to at least one of the one or more pre-stored speech queries based on the comparison.

11. The system of claim 9, wherein the one or more processors are further operable to offer the speech query as a crowdsourced task to the one or more crowdworkers, when the speech query is determined to be different from each of the one or more pre-stored speech queries based on the comparison.

12. The system of claim 8, wherein each of the one or more responses comprises at least one of one or more speech inputs or one or more textual inputs, wherein the one or more speech inputs comprise at least one of one or more spoken interpretations of the pre-stored speech query or one or more spoken variations of the pre-stored speech query, wherein the one or more textual inputs comprise at least one of one or more phonetic transcriptions of the pre-stored speech query or one or more textual interpretations of the pre-stored speech query.

13. The system of claim 12, wherein the one or more processors are further operable to validate a response received from a crowdworker of the one or more crowdworkers based on at least one of the ASR technique, a comparison of signal-to-noise ratio (SNR) of the one or more speech inputs of the response with a minimum SNR threshold, or a degree of similarity of the response with remaining of the one or more responses.

14. The system of claim 13, wherein the one or more processors are further operable to store the response as the one or more interpretations associated with the pre-stored speech query and a profile of the crowdworker in the database, when the response is determined to be valid based on the validation.

15. A computer program product for use with a computing device, the computer program product comprising a non-transitory computer readable medium, the non-transitory computer readable medium stores a computer program code for processing a speech query received from a user, the computer program code is executable by one or more processors in the computing device to:
determine one or more interpretations of the speech query using an automatic speech recognition (ASR) technique, wherein the ASR technique utilizes a database comprising one or more interpretations associated with each of one or more pre-stored speech queries and a profile of each of one or more crowdworkers, wherein the one or more interpretations associated with each of the one or more pre-stored speech queries are received as one or more responses from the one or more crowdworkers, in response to each of the one or more pre-stored speech queries being offered as one or more crowdsourced tasks to the one or more crowdworkers, and
rank one or more search results retrieved based on the one or more determined interpretations, wherein the ranking is based on a comparison of a profile of the user with the profile of each of the one or more crowdworkers associated with the one or more determined interpretations.

16. The computer program product of claim 15, wherein the computer program code is further executable by the one or more processors to compare the speech query with the one or more pre-stored speech queries.

17. The computer program product of claim 16, wherein the one or more interpretations of the speech query are determined using the ASR technique, when the speech query is determined to be similar to at least one of the one or more pre-stored speech queries based on the comparison.

18. The computer program product of claim 16, wherein the computer program code is further executable by the one or more processors to offer the speech query as a crowdsourced task to the one or more crowdworkers, when the speech query is determined to be different from each of the one or more pre-stored speech queries based on the comparison.

19. The computer program product of claim 15, wherein each of the one or more responses comprises at least one of one or more speech inputs or one or more textual inputs, wherein the one or more speech inputs comprise at least one of one or more spoken interpretations of the pre-stored speech query or one or more spoken variations of the pre-stored speech query, wherein the one or more textual inputs comprise at least one of one or more phonetic transcriptions of the pre-stored speech query or one or more textual interpretations of the pre-stored speech query.

20. The computer program product of claim 19, wherein the computer program code is further executable by the one or more processors to:
validate a response received from a crowdworker of the one or more crowdworkers based on at least one of the ASR technique, a comparison of signal-to-noise ratio (SNR) of the one or more speech inputs of the response with a minimum SNR threshold, or a degree of similarity of the response with remaining of the one or more responses, and
store the response as the one or more interpretations associated with the pre-stored speech query and a profile of the crowdworker in the database, when the response is determined to be valid based on the validation.
